(19) United States
(12) Patent Application Publication
(10) Pub. No.: US 2010/0290452 A1
(43) Pub. Date: Nov. 18, 2010

(54) Method and Device for Establishing a Subject-Related Communication link

(76) Inventor: Christian Maierhofer, Lilienfeld (AT)

Correspondence Address: STAAS & HALSEY LLP, SUITE 700, 1201 NEW YORK AVENUE, N.W., WASHINGTON, DC, 20005, US

(21) Appl. No.: 11/991,728

(22) PCT Filed: Aug. 24, 2006
(86) PCT No.: PCT/EP2006/065643

§ 371 Date: Jul. 27, 2010

(30) Foreign Application Priority Data
Sep. 9, 2005 (DE) 10 2005 043 041.4

(51) Int. Cl. H04L 12/66

(52) U.S. Cl. 370/352

(57) ABSTRACT

A method and a device establish a subject-related communication link between two users in a communication network. At least the called user is equipped with a telecommunication terminal and a computer workstation suitable for electronic messages. Electronic messages are provided with subject-related identifiers when the same are transmitted from the calling user to the called user. The calling user can indicate a subject-related identifier to a communication link between the calling user and the called user in the communication network when the communication link is established. The subject-related identifier is then transmitted along with the call information and is forwarded from the communication network to the computer workstation of the called user. The subject-related identifier is evaluated in the computer workstation, and messages including the subject-related identifier are then indicated to the called user.

### CROSS REFERENCE TO RELATED APPLICATIONS

This application is based on and hereby claims priority to German Application No. 10 2005 043 041.4 filed on Sep. 9, 2005 and PCT Application No. PCT/EP2006/065643 filed on Aug. 24, 2006, the contents of which are hereby incorporated by reference.

### BACKGROUND OF THE INVENTION

The invention relates to a method and to a device for establishing a subject-related communication link between two subscribers in a communication network, wherein at least the called subscriber has both a telecommunication terminal and a computer workstation suitable for electronic messages.

Communication is understood to be a mutual exchange of information in the form of voice, writing or images at the everyday human level.

In information technology and in communication technology, the term communication is characterized by the so-called transmitter/receiver model. In this model, the information is coded in characters and then transmitted from a transmitter at one location via a transmission channel to a receiver at another location. This process is also called information transmission, wherein the transmission of information can frequently take place not only unidirectionally—that is to say only in one direction from the transmitter to the receiver—but also bidirectionally. That is to say the communication is made possible in two directions wherein each of the two subscribers acts both as transmitter and as receiver.

In this arrangement, the transmission channel is a logical connection which is implemented with the aid of various resources (such as e.g. switching centers, interface systems, routers, radio-technology components etc.) and on a particular medium such as, for example, wire, air, etc. This logical connection which is used for exchanging information between a transmitter and a receiver is also called communication link.

All resources—such as, for example, switching centers, interface systems, routers, gateways, radio-technology components, cables etc. which are suitable for conveying information over spatial or temporal distance—that is to say for establishing communication links, are combined under the generic term communication network. A communication network connects network access points distant from one another with one another, by which the communication network can be used by the subscribers (transmitter, receiver).

Communication networks are, for example:
Telecommunication networks which are arranged as circuit-switched networks. In the case of telecommunication networks, a distinction can also be made, e.g. between the switched telephone network or Public Switched Telephone Network PSTN, the digital telecommunication network or Integrated Services Digital Network ISDN and the Public Land Mobile Network PLMN in which the network access is established via radio channels.
The subscribers of a telecommunication network use as network access points so-called telecommunication terminals which are either permanently connected to the telecommunication network via cables such as, e.g. in the case of PSTN or ISDN, or which can use cableless radio channels for the network access as in the case of the PLMN.
The subscribers to a communication link in a telecommunication network can be distinguished as a so-called calling subscriber by which the communication link is initiated and a so-called called subscriber.
Packet-oriented networks such as, for example, data networks or, as a special form of these, networks which are based on the Internet Protocol IP transport protocol and, apart from data transmission, are also used for the transmission of voice in the meantime, wherein special protocols such as, for example, the Session Initiation Protocol SIP or H.323 are used for setting up the communication link.

The network access points used for a packet-oriented network are in most cases computers which are in most cases connected to the packet-oriented network by cables and via special protocols.

From terminals such as e.g. telecommunication terminals, computers etc., the subscribers can use services with features for communication purposes. Such services provided by communication networks are, e.g. the transmission of data (e.g. electronic mail etc.) or the transmission of voice (e.g. voice telephony, IP telephony in packet-oriented networks etc.) from one terminal to another terminal so that information can be exchanged between these. In this context, however, not every service can be utilized from every terminal. For the utilization of IP telephony, it is thus necessary that the terminal e.g. the computer, is equipped with certain components suitable for voice transmission.

For the transmission of data and for exchanging information in written form between subscribers to a communication network, the electronic mail or e-mail service is used, for example. E-mail is a service provided by the so-called Internet which represents a totality of all networks connected to one another and using the IP transport protocol, in which an electronic message is electronically transmitted from a terminal, for example a computer of a subscriber, to another terminal, e.g. a computer of a personally addressed subscriber, the receiver. At the receiver, the electronic messages transmitted by e-mail are stored in a special file on the computer so that they can be called up, viewed and possibly processed further at any time.

The structure of an electronic message transmitted by the e-mail service is specified by the Request for Comments RFC 2822 “Internet Message Format” by the Internet Engineering Task Force IETF. An electronic message corresponding to this format includes a so-called header and the so-called message body or body.

The header is the part of the electronic message which does not contain any payload data but various administrative data. Such administrative data are, for example, sender, receiver or copy receiver of the electronic message, a brief description of the content of the electronic message—the so-called subject—or information about the path taken by the electronic message through the communication network.

The so-called message body or body of the electronic message then contains the actual payload data. These are the data of which the message entered by the transmitter and intended for the receiver is comprised without any sender or addressing information. Technically seen, any accompanying electronic documents, so-called attachments are also part of the message body.

Electronic messages are stored on computers in a special file which is also called a mailbox. The mailbox is a type of temporary memory for transmitted electronic messages from where the subscriber can call up the electronic messages in order to view them, answer them or to delete them. Mailbox systems also provide the subscriber the capability of further temporarily storing, printing his electronic messages, or also ordering them subject-specifically in order to retrieve individual electronic messages more easily if necessary.

In the private domain, but especially in the professional domain, the e-mail service is gaining more and more significance for communication purposes, apart from the direct communication between people and the communication via a communication link in a telecommunication network. According to the report “Information technology in companies and households 2004” by the Federal Office for Statistics, the Internet was used by 60% of the population in 2004, 84% of the Internet users also using the Internet for communication purposes such as e.g. sending out electronic messages.

E-Mail can be used for sending not only electronic messages but also electronic documents together with the text of the electronic message. These documents or electronic messages can then be referred to by the subscribers, for example during a communication link in a telecommunication network.

Today workstations are often equipped with a computer. According to the report “Information technology in companies and households 2004” by the Federal Office for Statistics, computers were used in the business processes in 84% of companies in the year 2004. In most cases, the e-mail service can also be used via these computers because, according to the report listed above, 78% of the companies use the Internet for business purposes and this provides E-Mail as a service. In addition, workstations are today equipped in most cases with a telecommunication terminal. Thus, the possibility exists that subscribers, during a communication link via the telecommunication terminals, look through those electronic messages sent to them and stored in mailboxes, which are currently being talked about.

However, one problem relates to the rise in number of electronic messages sent out and received, more and more electronic messages must be temporarily stored in mailboxes and administered. Even if the temporarily stored electronic messages can be subject-specifically ordered by the subscriber in mailboxes, it becomes more and more difficult for subscribers, due to the number of electronic messages, to find certain electronic messages or electronic documents possibly transmitted together with the electronic messages, relating to the respective subject of the conversation, for example during a subject-related communication link such as, e.g. in a telephone call. Sometimes, the problem also exists that electronic messages relating to a particular subject are temporarily stored in different part-areas of the mailbox by the subscriber and are then found only with difficulty or not at all.

### SUMMARY

One potential object, therefore, is to specify a method and a device suitable for carrying out the method by which the search for electronic messages at the computer workstation for subject-related communication links in a communication network is facilitated for the called subscriber.

The inventor proposes a method for establishing a subject-related communication link between two subscribers in a communication network, wherein at least the called subscriber, in addition to the telecommunication terminal, has a computer workstation suitable for electronic messages, wherein an electronic message is provided with a subject-related identifier during the transmission from the calling subscriber to the called subscriber, then during the establishment of a communication link is established between the calling subscriber and the called subscriber in the communication network, the subject-related identifier can be specified by the calling subscriber, this subject-related identifier is then sent along with call information, the subject-related identifier is forwarded by the communication network to the computer workstation of the called subscriber, the subject-related identifier is evaluated at the computer workstation and electronic messages with this subject-related identifier are then displayed to the called subscriber.

The advantages achieved with the proposed method and devices include, in particular, in that electronic messages are provided with subject-related identifiers which can already be input by the calling subscriber during the call establishment. The electronic messages matching the subject are then presented to the called subscriber at a computer workstation by this identifier which saves him a cumbersome search for the electronic messages. This also prevents electronic messages possibly important for the subject from not being found or overlooked by the called subscriber.

In a preferred development, a separate field for the subject-specific identifier is introduced in the header of the electronic message as a result of which the subject-specific identifier is automatically sent together with the other administrative data such as, e.g. sender, receiver etc. when an electronic message is sent out. Since the structure of an electronic message transmitted by the e-mail service is specified by the Request for Comments RFC 2822 “Internet Message Format” of the Internet Engineering Task Force IETF, a field corresponding to this standard can be introduced in the header for the Subject-related identifier. This field can be provided, for example, with an unambiguous number and optionally with a description wherein either the description or the sender of the electronic mail can be automatically entered.

It is advantageous if the communication network is arranged as Public Switched Telephone Network PSTN because this is widely used—particularly in the private domain or in the field of small and medium-sized undertakings.

It is also advantageous if the communication network is arranged as Integrated Services Digital Network ISDN because the Q.931 standard of the ITU-T, in which the signaling protocol in the ISDN is specified, makes it possible to send the subject-related identifier along during the setting-up of a call via the call-specific signaling.

A special variant of the embodiment of the method is distinguished by the fact that the communication network is arranged as Public Land Mobile Network PLMN since the subscribers, due to the use of so-called mobile telephones are thus no longer tied to a location. However, it should be ensured, particularly for the called subscriber, that he can access his electronic messages. This can be achieved by the use of mobile personal computers—so-called notebooks, which can be equipped for connection to a packet-oriented communication network by radio devices.

The inventor proposes that the communication network uses, for the establishment of the communication link between the subscribers, the Session Initiation Protocol SIP which is based on the Internet Protocol IP. SIP is used as protocol for the establishment of communication links for transmitting voice (e.g. IP telephony) in packet-oriented communication networks and specified in the Request for Comments RFC 3261 of the Internet Engineering Task Force IETF. The packet-oriented network based on the Internet Protocol is thus used not only for transmitting the electronic messages but also for voice telephony, as a result of which the subject-related identifier can be advantageously simply used for both services—e-mail and IP telephony—of the packet-oriented communication network.

Furthermore, the object is also achieved by a device which is arranged for carrying out the proposed method, and comprises an input unit to input the subject-related identifier by the calling subscriber, a transmitter to transmit the subject-related identifier to the communication network, a forwarding unit to forward the subject-related identifier from the communication network to the computer workstation of the called subscriber and an evaluation unit to evaluate the subject-related identifier at the computer workstation. By this device, the calling subscriber, on the one hand, can input the subject-related identifier in a simple manner before or during the establishment of the communication link. On the other hand, the called subscriber is spared the cumbersome search for electronic messages relating to a particular subject during the communication link.

A development of the device provides that the input unit, the transmitter for transmitting the subject-related identifier to the communication network and the forwarding unit to forward the subject-related identifier to the computer workstation are integrated in a telecommunication terminal as a result of which the calling subscriber can advantageously enter the subject-related identifier on his telecommunication terminal. This is of advantage particularly when a mobile telephone is used since then the calling subscriber does not need access to a computer. A special variant of the embodiment of the device is characterized by the fact that the telecommunication terminal is integrated in the computer workstation as a result of which the subscriber only needs to operate one terminal which has all the functions for carrying out the proposed method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary sequence of the proposed method for establishing a subject-related communication link and the exemplary integration of the device for carrying out the proposed method into a communication network KN1.

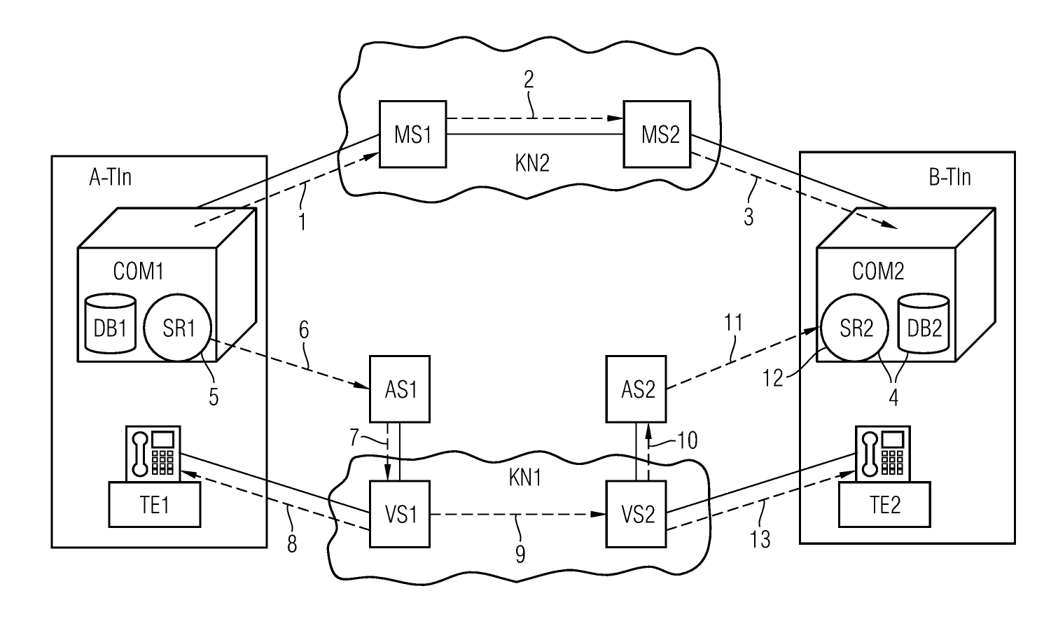

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The communication network KN1, which is arranged as telecommunication network, comprises, for example, two switching centers VS1 and VS2. To the switching center VS1 is linked, apart from a telecommunication terminal TE1 of the calling subscriber A-Tln, also an application server AS1 which can forward subject-related identifiers of electronic messages from the computer workstation COM1 of the calling subscriber A-Tln to the communication network KN1 or, respectively, also in the reverse direction. The computer workstation COM1 of the calling subscriber A-Tln comprises an additional component SR1 via which, on the one hand, subject-related identifiers can be input and which, on the other hand can evaluate subject-related identifiers arriving from the application server AS1, and a database DB1, in which subject-related identifiers of electronic messages are stored.

The switching center VS2 is connected to a telecommunication terminal TE2 of the called subscriber B-Tln. In addition, the switching center VS2 is tied to an application server AS2 which can forward subject-related identifiers of electronic messages from the communication network KN1 to the computer workstation COM2 of the called subscriber B-Tln or also in the reverse direction, respectively. The computer workstation COM2 of the called subscriber B-Tln also comprises an additional component SR2 via which, on the one hand, subject-related identifiers can be input and which, on the other hand, evaluates subject-related identifiers arriving from the application server AS2 and a database DB2, in which subject-related identifiers of electronic messages are stored.

To transmit electronic messages, a communication network KN2 is provided which is arranged as IP-based data network. The communication network KN2 conducts, e.g. by a Simple Mail Transfer Protocol SMTP, in combination with, for example, the Post Office Protocol Version 3 POP3 or Internet Message Access Protocol IMAP, the electronic messages from the calling subscriber A-Tln to the called subscriber B-Tln by using the message server MS1, MS2. The message servers MS1 and MS2, respectively, are in each case tied to the computer workstations COM1 and COM2 respectively of the subscribers A-Tln, B-Tln.

In a first step 1, an electronic message relating to a particular subject for the called subscriber B-Tln is sent from the computer workstation COM1 of the calling subscriber A-Tin to the message server MS1 of the communication network KN2, this electronic message having in its header a separate field for a subject-related identifier. In a second step 2, the electronic message is transmitted by the message server MS1 connected to the computer workstation COM1 to the message server MS2 connected to the computer workstation COM2. In a third step 3, the electronic message is then forwarded by the message server MS2 to the computer workstation COM2. In a fourth step 4, the component SR2 then recognizes that the received electronic message has a subject-related identifier and the component SR2 stores the subject-related identifier in the database DB2 with a reference to the associated electronic message.

If then the calling subscriber A-Tln establishes a communication link relating to a particular subject to the called subscriber B-Tln, the calling subscriber A-Tln can input the subject-related identifier for this subject at his computer workstation COM1 via the component SR1 in a fifth step 5. In a sixth step 6, the subject-related identifier is then forwarded via the computer workstation COM1 to the application server AS1. In a seventh step 7, the establishment of the communication link is then initiated by the application server AS1 at the switching center VS1 of the communication network KN1 and the subject-related identifier is handed over to the switching center VS1.

In an eighth step 8, the communication link between the switching center VS1 and the telecommunication terminal TE1 of the calling subscriber A-Tln is first established. Then the connection between the switching centers VS1 and VS2 is established in the communication network KN1 in a ninth step 9 and during this process the subject-related identifier is transmitted jointly with call information.

The switching center VS2 then triggers the application server AS2 with the communication link in a tenth step 10 and transmits to it the subject-related identifier. In an eleventh step 11, this subject-related identifier is then transmitted via the application server AS2 to the computer workstation COM2 of the called subscriber B-Tln. In a twelfth step 12, the subject-related identifier is evaluated there by the component SR2 and searched for associated electronic messages at the computer workstation COM2 which can then be displayed to the called subscriber B-Tln. In a thirteenth step 13, the communication link between the switching center VS2 and the telecommunication terminal TE2 of the called subscriber is then also established.

However, the application servers AS1 and AS3 respectively can also be integrated directly in the telecommunication terminals TE1, TE2 of the calling and called subscriber A-Tln and B-Tln, respectively. This simplifies the method to the extent that steps 7 and 8 are performed in one step since the subject-related identifier is sent along immediately when the communication link is established between the telecommunication terminal of the calling subscriber A-Tln and the switching center VS1. Similarly, steps 10 and 13 are performed in one step due to this integration because the communication link between the switching center VS2 and the telecommunication terminal TE2 of the called subscriber is established immediately when the subject-related identifier is transmitted. Step 11 and 12 are then performed following this step.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for establishing a subject-related communication link between a calling subscriber and a called subscriber in a communication network, the called subscriber having a telecommunication terminal and a computer workstation suitable for electronic messages, comprising:
providing an electronic message with a subject-related identifier during a transmission from the calling subscriber to the called subscriber;
specifying the subject-related identifier at the calling subscriber during a process of establishing a communication link between the calling subscriber and the called subscriber in the communication network;
sending the subject-related identifier specified by the calling subscriber, the subject-related identifier being sent along with call information;
forwarding the subject-related identifier by the communication network to the computer workstation of the called subscriber;
evaluating the subject-related identifier at the computer workstation of the called subscriber; and
displaying electronic messages with the subject-related identifier to the called subscriber.

12. The method as claimed in claim 11, wherein
the electronic message has a header, and
a separate field for the subject-related identifier is introduced in the header of the electronic message.

13. The method as claimed in claim 11, wherein the communication network is a Public Switched Telephone Network (PSTN).

14. The method as claimed in claim 11, wherein the communication network is an Integrated Services Digital Network (ISDN).

15. The method as claimed in claim 11, wherein the communication network is a Public Land Mobile Network (PLMN).

16. The method as claimed in claim 11, wherein the communication network uses, for establishing the communication link between the subscribers, the Session Initiation Protocol SIP which is based on the Internet Protocol IP.

17. The method as claimed in claim 12, wherein the communication network is a Public Switched Telephone Network (PSTN).

18. The method as claimed in claim 12, wherein the communication network is an Integrated Services Digital Network (ISDN).

19. The method as claimed in claim 12, wherein the communication network is a Public Land Mobile Network (PLMN).

20. The method as claimed in claim 12, wherein the communication network uses, for establishing the communication link between the subscribers, the Session Initiation Protocol SIP which is based on the Internet Protocol IP.

21. At least one device to establish a subject-related communication link between a calling subscriber and a called subscriber in a communication network, the called subscriber having a telecommunication terminal and a computer workstation suitable for electronic messages, comprising:
an input unit at the calling subscriber to input a subject-related identifier into an electronic message while establishing a communication link between the calling subscriber and the called subscriber;
a transmitter to transmit the subject-related identifier along with call information to the communication network;
a forwarding unit to forward the subject-related identifier from the communication network to the computer workstation of the called subscriber;
an evaluation unit to evaluate the subject-related identifier at the computer workstation of the called subscriber.

22. The device as claimed in claim 21, wherein
the calling subscriber has a telecommunication terminal, and
the input unit, the transmitter and the forwarding unit are integrated in the telecommunication terminals of the calling subscriber and the called subscriber.

23. The device as claimed in claim 21, wherein
the calling subscriber has a computer workstation, and
the telecommunication terminals are integrated in the respective computer workstations of the calling subscriber and the called subscriber.
